(19) United States
(12) Patent Application Publication
(10) Pub. No.: US 2009/0157216 A1
(43) Pub. Date: Jun. 18, 2009

(54) AUTOMATED SCHEDULING OF TEST WAFER BUILDS IN A SEMICONDUCTOR MANUFACTURING PROCESS FLOW

(76) Inventors: CHANDRASHEKAR KRISHNASWAMY, Austin, TX (US); Steven C. Nettles, Johnson City, TX (US); Larry D. Barto, Austin, TX (US)

Correspondence Address: WILLIAMS, MORGAN & AMERSON, 10333 RICHMOND, SUITE 1100, HOUSTON, TX, 77042, US

(21) Appl. No.: 11/956,941

(22) Filed: Dec. 14, 2007

(51) Int. Cl. G06F 19/00

(52) U.S. Cl. 700/121

(57) ABSTRACT

An automated, computer-implemented method for managing test wafers in an integrated, automated semiconductor manufacturing environment includes: managing a test wafer inventory; consuming inventoried test wafers in the automated process flow; and distributing the consumed test wafers according to their level of usage after an evaluation thereof. An automated, computer-implemented method for use in semiconductor manufacturing includes: monitoring test wafer utilization in an automated process flow; maintaining an inventory of test wafers of a plurality of different types responsive to the monitored utilization; and managing the test wafer utilization of the test wafer inventory. An automated, computer-implemented method for use in semiconductor manufacturing includes: kitting a lot of test wafers; instantiating a software-implemented test lot scheduling agent for the kitted lot, the agent being capable of: scheduling a build for the kitted lot; or scheduling the kitted lot as a resource for consumption in an automated process flow.

### BACKGROUND OF THE INVENTION

1. Field of the Invention

The present invention pertains to semiconductor fabrication, and, more particularly, automated scheduling of a test wafer build in an semiconductor manufacturing process flow.

2. Description of the Related Art

Integrated circuits, or microchips, are manufactured from modern semiconductor devices containing numerous structures or features, typically the size of a few micrometers. The features are placed in localized areas of a semiconducting substrate, and are either conductive, non-conductive, or semi-conductive (i.e., rendered conductive in defined areas with dopants). The fabrication process generally involves processing a number of wafers through a series of fabrication tools. Each fabrication tool performs one or more of four basic operations in which layers of materials are added, removed, and/or treated during fabrication to create the integrated, electrical circuits that make up the device.

The fabrication essentially comprises the following four basic operations:
layering, or adding thin layers of various materials to a wafer from which a semiconductor is produced;
patterning, or removing selected portions of added layers;
doping, or placing specific amounts of dopants in selected portions of the wafer through openings in the added layers; and
heat treating, or heating and cooling the materials to produce desired effects in the processed wafer.
   Although there are only four basic operations, they can be combined in hundreds of different ways, depending upon the particular fabrication process. See, e.g., Peter Van Zant, Microchip Fabrication, A Practical Guide to Semiconductor Processing (3d Ed. 1997 McGraw-Hill Companies, Inc.) (ISBN 0-07-067250-4). The four basic operations are performed in accordance with an overall process to finally produce the finished semiconductor devices.

The precision with which these four operations are performed is important. The various parts of the integrated circuits created by the operations must be precisely located or they will not work. If the circuits do not work, then the product wafer is scrapped, or thrown away. Even one mistake can ruin the entire wafer. This is costly not only from the standpoint of lost materials, but also from the standpoint of lost processing time. Furthermore, these types of processing errors frequently are repeated, meaning that more than one product wafer, or even more than one lot of product wafers, may to be scrapped.

Consequently, before a fabrication tool can be placed into a process flow, it undergoes a series of qualifications procedures, or “quals”, to make sure it is calibrated and performing both accurately and precisely. A “qualified” tool, however, does not necessarily continue to operate within specifications for all time. Over time, settings drift, instruments age, and other adverse developments occur that may cause the fabrication tool to lose the required degree of precision. Regularly scheduled preventive maintenance, after which the fabrication tool is qualified again, help mitigate these problems. But these problems can sometimes occur more often than preventive maintenance routines are performed. Process tools also periodically undergo preventive maintenance to prolong the life of the tool, to adjust settings, etc. The fabrication tool must once again undergo a qual after a preventative maintenance session before reintroduction into the process flow.

A qual generally involves processing a plurality of test wafers on the fabrication tool. Test wafers are wafers or wafer pieces that are blank or partially processed by selected process steps and subsequently evaluated to determine the quality of the operation being performed. (Sometimes test wafers are instead referred to as “monitor wafers”.) Test wafers are processed through a fabrication tool in a similar manner to the product wafers. Typically, a lot of wafers is kitted, the lot comprising different types of test wafers. The lot is then processed through the fabrication tool being qualified.

Once processed, the test wafers are reviewed to evaluate the performance of the fabrication tool. The reviewed wafers are then de-kitted, or broken out of the lot, and disposed of depending on their utilization. Some wafers might be reused as the same type of wafer, while others might be downgraded to a different type of wafer, while others might be sent to a waste bin for recycling or scrapping.

However, the testing must be conducted within the context of the operations of the process flow as a whole. As importantly, the process flow may comprise just one of several, or many, in a fabrication facility, or “fab”. The process flows furthermore frequently overlap, sharing tools and resources. Thus, testing a fabrication tool in a process flow may have adverse effects that ripple throughout the fab, substantially impairing the productivity of the fab.

Furthermore, test wafers frequently have to be “built”, or processed through a series of steps. Process flows typically do not include equipment dedicated to test wafer builds. Equipment intended for processing product wafers must therefore be re-directed temporarily to test wafer builds when needed. During this period, product wafers are unprocessed, which decreases the efficiency, throughput, and profitability of the process flow. Great effort is therefore generally expended to schedule test wafer builds in manner minimizing adverse impact to the production.

Still further, management of test wafer inventories can create difficulties throughout the process flow. For instance, excess numbers of test wafers can be generated to meet demands by test wafers out of position in the process flow so that they are effectively unavailable for use even though they are dormant. In turn, these excess numbers might necessitate capital outlay to acquire material handling resources over and above what might otherwise be needed if the test wafer numbers were more efficiently managed. The additional material handling resources also require maintenance, thereby increasing overhead, and complicate fab design and layout.

The problems associated with test wafers for quals arise from several sources. One source is that the management and consumption tasks are disjointed, as opposed to integrated. For instance, managing the test wafer inventory is typically handled separately from the managing utilization of the test wafers which is typically handled separately from distribution of the utilized test wafers after they are de-kitted. Another source is that the system is not automated. One or more wafer fab technicians are assigned to the handling of each of these management tasks. The complexity of the fab and sheer number of test wafers, process tools, etc. can quickly overwhelm the capabilities of any tech.

The present invention is directed to resolving, or at least reducing, one or all of the problems mentioned above.

### SUMMARY OF THE INVENTION

In one aspect, the invention includes an automated, computer-implemented method for managing test wafers in an integrated, automated semiconductor manufacturing environment, the method comprising: managing a test wafer inventory; consuming inventoried test wafers in the automated process flow; and distributing the consumed test wafers according to their level of usage after an evaluation thereof.

In another aspect, the invention includes an automated, computer-implemented method for use in semiconductor manufacturing, comprising: monitoring test wafer utilization in an automated process flow; maintaining an inventory of test wafers of a plurality of different types responsive to the monitored utilization; and managing the test wafer utilization of the test wafer inventory.

In yet another aspect, the invention includes an automated, computer-implemented method for use in semiconductor manufacturing, comprising: kitting a lot of test wafers; instantiating a software-implemented test lot scheduling agent for the kitted lot, the agent being capable of: scheduling a build for the kitted lot; or scheduling the kitted lot as a resource for consumption in an automated process flow.

In still other aspects, the invention includes integrated, automated semiconductor manufacturing environments in which a computing system is capable of performing those methods and program storage media encoded with instructions that, when executed by a computing device, perform those methods.

### BRIEF DESCRIPTION OF THE DRAWINGS

The invention may be understood by reference to the following description taken in conjunction with the accompanying drawings, in which like reference numerals identify like elements, and in which:

FIG. 1 conceptually depicts a portion of one particular embodiment of a process flow constructed and operated in accordance with the present invention;

FIG. 2 conceptually depicts, in a partial block diagram, selected portions of the hardware and software architectures, respectively, of the computing devices in FIG. 1;

FIG. 3 illustrates one particular embodiment of a method practiced in accordance with the present invention;

FIG. 4A-FIG. 4C illustrate constituent acts of the steps of the method illustrated in FIG. 3;

FIG. 5A-FIG. 5D illustrate constituent acts of the steps of the method illustrated in FIG. 4A-FIG. 4C;

FIG. 6 conceptually depicts a portion of a second particular embodiment of a process flow constructed and operated in accordance with the present invention; and

FIG. 7 illustrates a technique used for scheduling in the process flow of FIG. 6. While the invention is susceptible to various modifications and alternative forms, the drawings illustrate specific embodiments herein described in detail by way of example. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF THE INVENTION

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

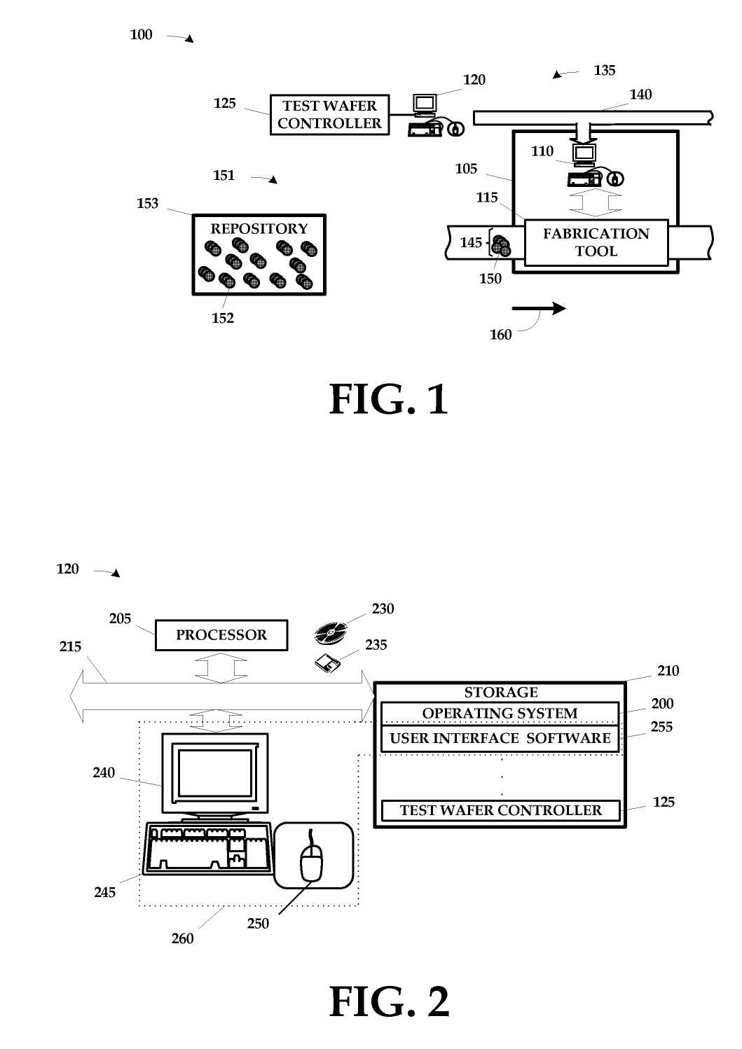

FIG. 1 illustrates a portion of an automated process flow 100, comprising a station 105. The station 105 includes a computing apparatus 110 and a fabrication tool 115. In the illustrated embodiment, the computing apparatus 110 is a workstation. The computing device 110 may be implemented in virtually any type of electronic computing device, and may even be, in some alternative embodiments, a processor or controller embedded in the fabrication tool 115. The invention is not limited by the particular implementation of the computing apparatus 110. The fabrication tool 115 may be any kind of semiconductor manufacturing process tool used for fabrication, as opposed to meteorology. The fabrication tool 115 may therefore be used to perform any of the four operations set forth above—i.e., layering, patterning, doping, or heat treating. Thus, the fabrication tool 115 may be a photolithography stepper, a polishing tool, an etching tool, a deposition tool, etc.

The portion 100 also includes a computing apparatus 120 on which resides, inter alia, a test wafer controller 125. FIG. 2 depicts selected portions of the hardware and software architectures, respectively, of the computing apparatus 120 programmed and operated in accordance with the present invention. Some aspects of the hardware and software architecture (e.g., the individual cards, the basic input/output system (“BIOS”), input/output drivers, etc.) are not shown. These aspects are omitted for the sake of clarity, and so as not to obscure the present invention. As will be appreciated by those of ordinary skill in the art having the benefit of this disclosure, however, the software and hardware architectures of the computing apparatus 120 will include many such routine features.

In the illustrated embodiment, the computing apparatus 120, like the computing apparatus 110, is a workstation. The computing apparatus 120 employs a UNIX-based operating system (“OS”) 200, but the invention is not so limited. The computing apparatus 120 may be implemented in virtually any type of electronic computing device such as an embedded processor, a notebook computer, a desktop computer, a mini-computer, a mainframe computer, or a supercomputer. The invention also is not limited to UNIX-based operating systems. Alternative operating systems (e.g., Windows™-based or disk operating system (“DOS”)-based) may also be employed. The invention is not limited by the particular implementation of the computing apparatus 120.

The computing apparatus 120 also includes a processor 205 communicating with storage 210 over a bus system 215. The storage 210 typically includes at least a hard disk (not shown) and random access memory (“RAM”) (also not shown). The computing apparatus 120 may also, in some embodiments, include removable storage such as an optical disk 230, or a floppy electromagnetic disk 235, or some other form, such as a magnetic tape (not shown) or a zip disk (not shown). The computing apparatus 120 includes a monitor 240, keyboard 245, and a mouse 250, which together, along with their associated user interface software 255 comprise a user interface 260. The user interface 260 in the illustrated embodiment is a graphical user interface (“GUI”), although this is not necessary to the practice of the invention.

Returning to FIG. 1, the computing apparatus 110 and the computing apparatus 120 are part of a computing system 135. The computing system 125 is, in the illustrated embodiment, a distributed computing system that permits great flexibility in the situs of individual software components. Thus, the location of software components such as the test wafer controller 125 are not limited to those shown in the illustrated embodiment. In alternative embodiments, such software components may reside elsewhere in the computing system 135.

The computing system 135 may be, for example, a local area network (“LAN”), wide area network (“WAN”), system area network (“SAN”), intranet, or even a portion of the Internet. The computing system 135 employs a networked client/server architecture, but alternative embodiments may employ, e.g., a peer-to-peer architecture. Thus, in some alternative embodiments, the computing devices 110, 120 may communicate directly with one another.

The communications links 140 of the computing system 135 may be one or more of wireless, coaxial cable, optical fiber, or twisted wire pair links, for example. The computing system 135, in embodiments employing one, and the communications links 120 will be implementation specific and may be implemented in any suitable manner known to the art. The computing system 135 may employ any suitable communications protocol known to the art, e.g., Transmission Control Protocol/Internet Protocol (“TCP/IP”).

The fabrication tool 115 is shown preparing to operate on a lot 145 of test wafers 150 (only one indicated). The wafers 150 comprise a portion of an inventory 151 of test wafers 150, 152. The wafers 150 may be referred to as “active,” in that they are currently being utilized or de-kitted, e.g., from a lot 145. The wafers 152 (only one indicated) may be referred to as “dormant,” in that they reside in a repository 153 and are not being utilized. The inventory 151 includes different “types” of test wafers 150, 152, e.g., Type I, Type II, Type III, etc. as defined by the applicable qual procedures for the process flow 100. The design and construction of the different types of test wafers 150, 152 may be in accordance with conventional practice.

The lot 145 may include any number of wafers 150. Typically, the lot 145 will contain a plurality of wafers 150 of different types. For instance, in a simple example, the lot 145 may contain three Type I wafers 150, two Type II wafers 150, and two Type III wafers 150. As those in the art having the benefit of this disclosure will appreciate, the composition of the lot 145 will depend to some degree on the operation of the fabrication tool 115 and other similar factors such as the applicable qual procedure being run.

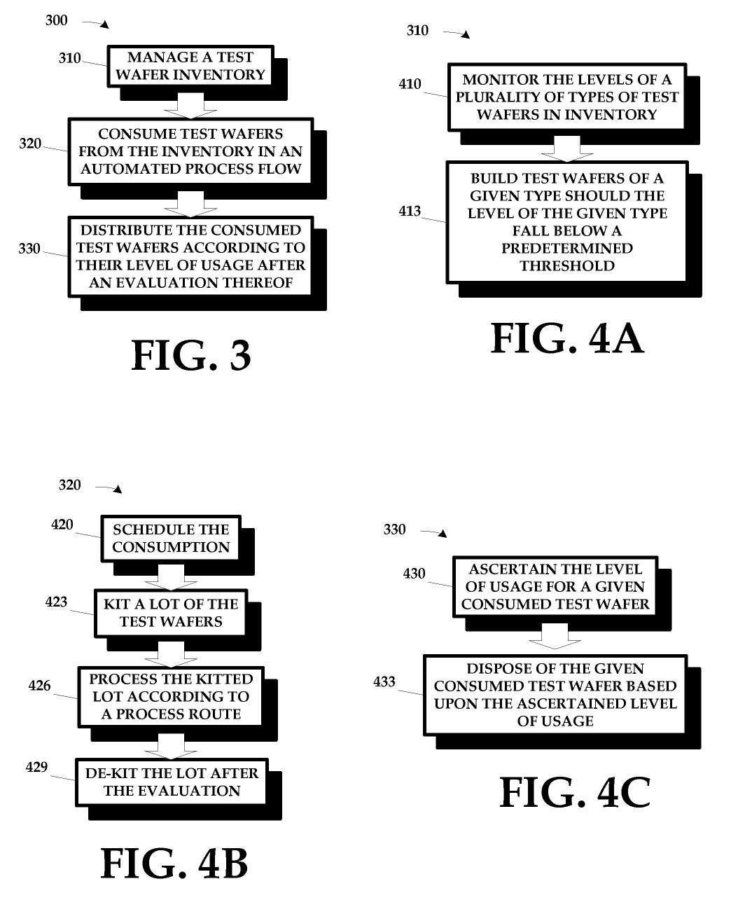

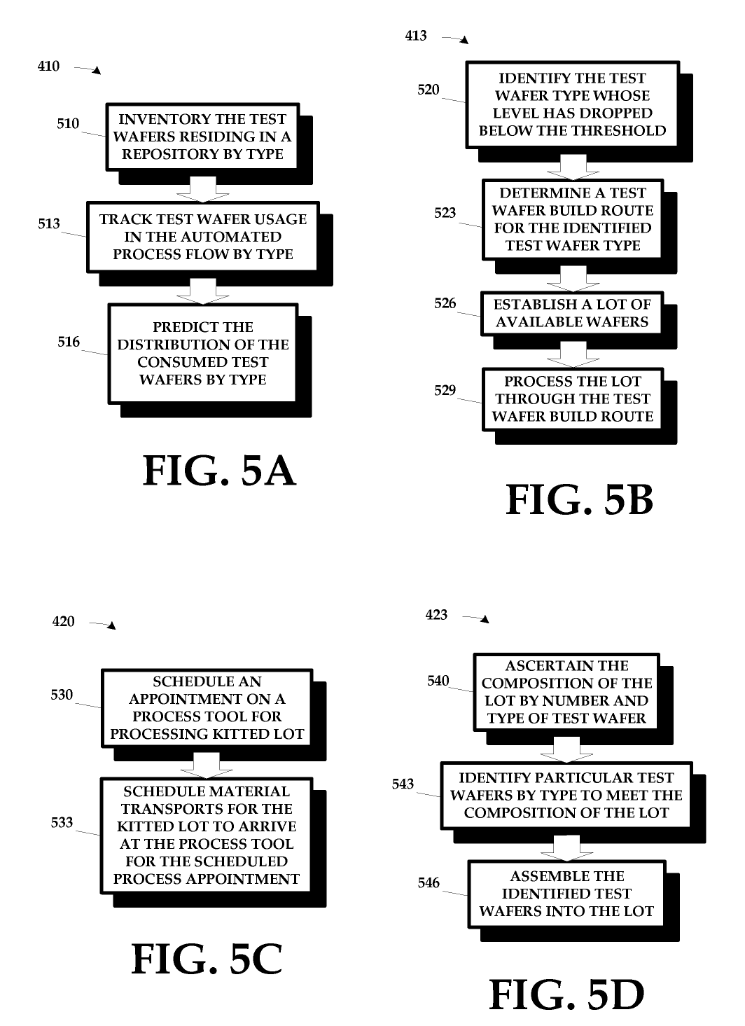

The test wafer controller 125 schedules the testing of the fabrication tool 115 in accordance with the method 300, shown in FIG. 3, FIG. 4A-FIG. 4C, and FIG. 5A-FIG. 5D. The method 300 is an automated, automated, computer-implemented method for managing test wafers in an integrated, automated semiconductor manufacturing environment. In one particular embodiment, the process flow 100 may be integrated and automated through implementation of an Advanced Process Control (“APC”) framework. An APC system comprises a distributed software system of interchangeable, standardized software components permitting run-to-run control and fault detection/classification in the process flow 100. The present invention is layered on top of the APC System to achieve a nearly autonomously operating semiconductor fabrication process flow in terms of test wafer utilization.

The method 300, shown in FIG. 3, begins by first managing (at 310, FIG. 3) the test wafer inventory 151. As those in the art having the benefit of this disclosure will appreciated, most fabs have a “safety stock” requirement. The safety stock requires that a certain minimum number of each type of test wafers 150, 152, of each type. Thus, as is shown in FIG. 4A, the test wafer controller 125 monitors (at 410, FIG. 4A) the levels of test wafers 150, 152 in the inventory 151 by type and builds (at 413, FIG. 4A) test wafers 150, 152 should the level of a given type fall below a predetermined threshold. The predetermined threshold may be the safety stock requirement or may be some function of the safety stock requirement.

As was noted above, the inventory 151 includes both the dormant wafers 152 in the repository 153 and the active wafers 152 being utilized in the process flow 100. As is shown in FIG. 5A, the test wafer controller 125 therefore inventories (at 510, FIG. 5A) the test wafers 150 residing in the repository 153 by type, e.g., the number of Type I test wafers 152, number of Type II test wafers 152, etc. The test wafer controller 125 also tracks (at 513, FIG. 5A) the use of the active test wafers 150 in the automated process flow 100 by type. Finally, the test wafer controller 125 predicts (at 516, FIG. 5A) the distribution of the active test wafers 150 by type, e.g., how many of the wafers 150 will remain at their current type, how many will be downgraded, and how many will be otherwise disposed. Thus, the test wafer controller 125 tracks the number of Type I test wafers, for example, in the repository 153 and in the process flow 100, and then predicts how many Type I test wafers will be available after those being processed are finished. The test wafer controller 125 does this for each type of test wafer 150, 152.

Returning to FIG. 4A, should the test wafer controller 125's monitoring (at 410, FIG. 4A) indicate that the level of a given type will fall below a predetermined threshold, it begins building (at 413, FIG. 4A) more of that type of test wafer. In general, as is shown in FIG. 5B, this involves first identifying (at 520, FIG. 5B) the test wafer type whose level has dropped below the threshold. This information ordinarily will be readily available through the inventorying records in the maintenance of the test wafer inventory discussed above.

The test wafer controller 125 then determines (at 523, FIG. 5B) a test wafer build route for the identified test wafer type. As those in the art having the benefit of this disclosure will appreciate, a test wafer 150, 152 is “built” from a blank or another test wafer 150, 152 of another type. For instance, a Type II test wafer may be “built” from a Type I test wafer that has exceeded some level of usage and has been downgraded. To build a test wafer, an available wafer of the proper type is processed through a series of operations within the process flow 100. The sequence of processing operations is the “build route.” To determine the proper build route for the test wafer type to be built, the test wafer controller 125 can, for example, retrieve that information from a data store (not shown) associated with the process flow 100.

Once the test wafer controller 125 determines (at 523, FIG. 5B) the build route, it establishes (at 526, FIG. 5B) a lot, e.g., a lot 145, of available wafers. An “available” wafer is any wafer 150, 152 not currently not currently included in a kitted lot or designated for kitting into a lot. Thus, available wafers will include, for example, dormant test wafers 152 residing the repository 153 and active wafers 150 that have been de-kitted from a lot 145 but not yet returned to the repository 153. Typically, an “available” wafer is a test wafer 150, 152 that has recently been downgraded and has been designated for building into another type of test wafer. However, in some embodiments, if there are no recently downgraded test wafers, the inventory may be scavenged for other test wafers of the desired type. For instance, consider a situation in which a Type II test wafer is needed to build a Type III test wafer and there are no recently downgraded Type II test wafers for use in building a Type III test wafer. The test wafer controller 125 may then designate, for example, the most used Type II test wafer 152 in the repository 153 as an “available” wafer.

Once the lot 145 is established, the test wafer controller 125 processes (at 529, FIG. 5B) the lot 145 through the test wafer build route. As those in the art having the benefit of this disclosure will appreciate, the test build route will be a series of operations to be performed on the lot 145 in the process flow 100 on, for example, the fabrication tool 115. Thus, the test wafer build is performed on the same process tools as those on which product wafers are processed. In one aspect of the present invention discussed below, the test wafer builds are scheduled so as to mitigate any disruption to the normal operation of the process flow 100 in production. Note also that the newly built test wafers may be deposited in the repository 153 or may immediately go into a lot 145, depending on the needs of the process flow 100.

Returning to FIG. 3, in addition to managing (at 310, FIG. 3) the inventory, the method 300 also includes consuming (at 320, FIG. 3) test wafers 150, 152 from the inventory 151 by the automated process flow 100. Referring now to FIG. 4B, the consumption (at 320, FIG. 3) begins by scheduling (at 420, FIG. 4B) it. The consumption occurs in the process flow 100, and so the consumption is scheduled in a manner discussed more fully below to mitigate any disruption to the normal operation of the process flow 100 in production. As is shown in FIG. 5C, scheduling the consumption includes, in this particular embodiment, scheduling (at 530, FIG. 5C) an appointment on a fabrication tool 115 for processing the kitted lot 145. It also includes scheduling (at 533, FIG. 5C) material transports for the kitted lot 145 to arrive at the fabrication tool 115 for the scheduled process appointment.

Returning to FIG. 4B, the consumption (at 320, FIG. 3) continues by kitting (at 423, FIG. 4B) the lot 145 of the test wafers 150, 152. A kitted lot 145 will typically comprise several different types of test wafers, as was discussed above. Thus, the test wafer controller 125, as is shown in FIG. 5D, first ascertains (at 540, FIG. 5D) the composition of the lot 145 by number and type of test wafer. For example, the test wafer controller 125 ascertains how many Type I test wafers, how many Type II test wafers, etc. The test wafer controller 125 then identifies (at 543, FIG. 5D) particular test wafers by type to meet the composition of the lot 145. That is, the test wafer controller 145 identifies which of the active lots 150 and which of the dormant lots 152 it will use to comprise the lot 145. Note that, in this particular embodiment, the test wafer controller 125 schedules ahead. It can therefore determine whether an active wafer 150 will be available at the time it is needed even if it is currently in use. The identified (at 543, FIG. 5D) test wafers are then assembled (at 546, FIG. 5D) into the lot 145.

Returning again to FIG. 4B, the consumption (at 320, FIG. 3) continues by processing (at 426, FIG. 4B) the kitted lot 145 according to a process route 160. In the illustrated embodiment, this means initiating and executing the previously scheduled (at 530, 533, FIG. 5C) processing appointment and material transports. The process route 160 will typically include multiple processes on multiple fabrication tools 115. Thus, processing (at 426, FIG. 4B) the kitted lot 145 will usually include multiple processing appointments on multiple fabrication tools 115 spread across the process flow 100.

The consumption (at 320, FIG. 3) concludes by de-kitting (at 429, FIG. 4B) the lot after the evaluation. The evaluation in question here is the evaluation of the test wafers 150 to determine whether the fabrication tool 115 has passed the qualification procedure. Once the evaluation is completed, the kitted test wafers 150 are de-kitted from the lot 145 for automatic distribution according to their usage. So, for example, a Type I test wafer that has been used less than a certain number of times might be built again into a Type I test wafer and then returned to the repository 153 as a Type I wafer. On the other hand, a Type I test wafer that exceeds that certain number might be downgraded to a Type II test wafer, undergo a Type II build, and then returned to the repository as a Type II wafer. Or, the test wafer might be scrapped altogether if it has undergone too many builds.

Returning to FIG. 3, the method 300 then distributes (at 330, FIG. 3) the consumed test wafers 150 according to their level of usage after an evaluation thereof. In the illustrated embodiment, as is shown in FIG. 4C, this distribution includes first ascertaining (at 430, FIG. 4C) the level of usage for a given consumed test wafer, and, second, disposing (at 433, FIG. 4C) of the given consumed test wafer based upon the ascertained level of usage. The level of usage can usually be retrieved from a data store (not shown) in the computing system 135. Once this level is known, the test wafer controller 125 can then return the given test wafer for further consumption at the same type, or downgrade the given test wafer to a second type, or consign the given test wafer 150 to a waste bin (not shown).

Note that, although the various functionalities are presented sequentially above, this is not necessarily the case. Many of the functionalities are, in fact, exercised concurrently. For instance, referring now to FIG. 3, the test wafer controller 125 manages the inventory (at 310, FIG. 3) and controls the consumption (at 320, FIG. 3) and distribution (at 330, FIG. 3) concurrently. Within each of these tasks, the constituent functionalities may also be concurrently exercised. For instance, the lot 145 may be kitted (at 423, FIG. 4B) while the processing appointment and material transports are being scheduled (at 420, FIG. 4B).

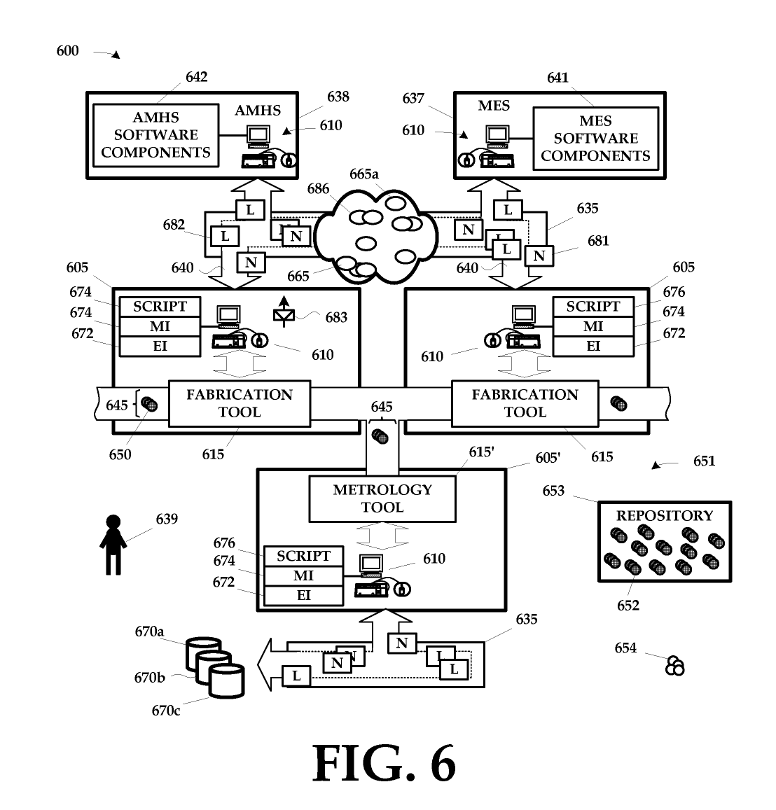

Those skilled in the art having the benefit of this disclosure will appreciate that the present invention can be extrapolated across a fab or multiple process flows comprising multiple fabrication tools. FIG. 6 conceptually illustrates a portion of a second embodiment of a process flow 600 constructed and operated in accordance with the present invention. The illustrated portion of the process flow 600 includes two stations 605, each station 605 including a computing apparatus 610 communicating with a fabrication tool 615. The fabrication tools 615 may be, for example, photolithography steppers, polishing tools, etching tools, and deposition tools, etc. The stations 605 communicate with one another over communications links 640 of a computing system 635. The fabrication tools 615 are shown in FIG. 6 processing lots 645 of test wafers 650, as will be discussed further below.

The process flow 600 also includes a station 605′ comprising a computing apparatus 610 and a meteorology tool 615′. The computing apparatus 610 of the station 605′ also comprises a portion of the computing system 635. The meteorology tool 615′ is used in the examining the test wafer 650 when it is processed to evaluate the operation of the fabrication tools 115. The meteorology tool 615′ may provide pre-processing and/or post-processing meteorology data to process controllers for the fabrication tools 615. Depending on the results of the evaluation, corrective action may be taken to adjust the operation of the fabrication tool 615.

The process flow 600 furthermore includes, in accordance with the present invention, a plurality of active and dormant test wafers 650, 602. The active test wafers 650 are grouped into lots 645. The dormant test wafers 652 are stored in a repository 653. The test wafers 650, 652 comprises a number of different types of test wafers, i.e., Type I, Type II, etc.

The process flow 600 also includes portions of an automated “Manufacturing Execution System” (“MES”) 637, an automated materials handling system (“AMHS”) 638, and other factory controls not otherwise shown. These factory controls integrate and help automate the process flow 600. The automated MES 637 enables a user 639 to view and manipulate, to a limited extent, the status of machines and tools, or “entities,” in a manufacturing environment, i.e., the process flow 600. In addition, the MES 637 permits dispatching and tracking of lots 645 or work-in-process to enable resources to be managed in the most efficient manner. The AMHS 638 “handles” the lots 645 and facilitates their transport from one station 605 to another, as well as other locations in the process flow 600. The AMHS 638 is, in the illustrated embodiment, what is known as a “unified AMHS”, although this is not necessary to the practice of the invention.

Both the MES 637 and the AMHS 638 include software components 641, 642, respectively. The MES 637 and the AMHS 638 operate and are used in conventional fashion. The software components 641, 642 are shown residing on separate computing apparatus 610. However, since the computing system 635 is a distributed system, the situs of all software elements, such as the software components 641, 642, is not material. Thus, the software components 641, 642 may reside elsewhere in the computing system 635 or even on the same computing apparatus.

The computing system 635 furthermore includes one or more data store(s) 670 that include a variety of information about the process flow 600 and, more generally, the fab. The data store(s) 670 include data defining the state of the fab, as well as metrics concerning its operation. The data store 670 is used to store a wide variety of information that may be used in the automated control of the factory, including:
associations among various pieces of equipment, e.g., the association of the nearest stocker to a process tool;
the duration of certain events in the fab, e.g., the duration of process-operations that might be scheduled or the duration of material transports from one location to another;
the location of certain manufacturing domain entities, e.g., the locations of lots or mobile resources; and
the states of the factory.
   Thus, the data store 670 contains data indicating the definition and state of the AMHS 138 and the status of the factory as a whole. The data may be stored in any suitable data structure known to the art. This data can be populated, updated, retrieved, and analyzed to facilitate the management and control of the fab, including the process flow 600.

The process flow 600 also includes a plurality of “notifiers” 681 (only one indicated) and “listeners” 682 (only one indicated) that track events occurring in the process flow 600. Notifiers 681 “publish” detected events to their subscribing listeners 682 when changes occur within the process flow 600. For instance, when a fabrication tool 615 finishes processing a lot 645 of test wafers 650, it will send a message 683 indicating that it has done so. A notifier 681 looking for this type of event, upon receiving the message 683, will publish that the event has occurred. The listeners 682 subscribe to notifiers 681 that publish the events they are interested, by virtue of their programming, in tracking. Thus, when the notifier 681 publishes that the fabrication tool 615 has finished processing the lot 645, it publishes that event to its subscribing listeners 682. The subscribing listeners 682 then report the event to other software components of the computing system 635 that have subscribes to the listeners 682 for that very purpose. Note that the use listeners 682 and notifiers 681 in this manner is known to the art, and any suitable technique may be employed.

The process flow 600 also includes a plurality of software-implemented agents, or “software agents” 665 (only one indicated) residing in the computing system 635. The software agents 665 each represent some “manufacturing domain entity,” e.g., a lot 645 or a fabrication tool 615. The software agents 665, schedule activities on behalf of and control the progress of the lots 645 of wafers 635 through the fabrication process. In furtherance of these objectives, the software agents 665 interface with the software components 641, 642 of the MES 637 and AMHS 638, and the fabrication tools 615. The manner in which this interface and integration occurs is implementation specific, depending upon the makeup and configuration of the MES 637, AMHS 638, and the other factory control systems.

In the illustrated embodiment, the process flow 600 implements an Advanced Process Control (“APC”) framework (not shown) in the computing system 635. In some embodiments, as in the embodiment illustrated in FIG. 6, the APC framework is a factory-wide software system. More particularly, an APC system comprises a distributed software system of interchangeable, standardized software components permitting run-to-run control and fault detection/classification in the process flow 600. The software components of the APC System implement an architectural standard based on the Semiconductor Equipment and Materials International (“SEMI”) Computer Integrated Manufacturing (“CIM”) Framework compliant system technologies and the Advanced Process Control (“APC”) Framework. The CIM (SEMI E81-0699—Provisional Specification for CIM Framework Domain Architecture) and APC (SEMI E93-0999—Provisional Specification for CIM Framework Advanced Process Control Component) specifications are publicly available from SEMI. SEMI may be contacted at 8310 Capital of Texas Highway North, Suite 290 Austin, Tex. 78731, phone: 512-349-2422, fax: 512-349-2442, internet address: <http://www.semi.org>.

This particular architecture relies heavily on software utilizing object oriented programming and employs the Object Management Group's (“OMG”) Common Object Request Broker Architecture (“CORBA”) and CORBA_Services specifications for distributed object systems. Information and specifications for the OMG CORBA architecture are also readily, publicly available. An exemplary software system capable of being adapted to perform the functions of the APC System as described herein is the Catalyst system commercially offered by KLA-Tencor, Inc. KLA-Tencor may be contacted at: 160 Rio Robles, San Jose, Calif. 95134, phone: 408-875-6000, fax: 408-875-3030, <http://www.kla-tencor.com>. Additional information regarding the Catalyst system is also available from KLA-Tencor on their website at <http://www.kla-tencor.com/controlsolutions/catalystapc.html>.

Deployment of the control strategy taught by the present invention onto the APC framework could require a number of software components, such as equipment interfaces (“EIs”) 672 and machine interfaces (“MIs”) 674. Each process tool (e.g., the fabrication tools 615, meteorology tool 615′) is generally connected to an EI 672. The EI 672 is connected to a MI 674 that facilitates communications between the manufacturing tool and the manufacturing framework. The machine interface can generally be part of the APC system. In addition to components within the APC framework, a computer script 676 is written for each of the process tools that is used to control the process operation of the manufacturing tool. The implementation of an APC system in this fashion and using various software components such as EIs 672 and MIs 673 is known in the art. Therefore, for the sake of clarity and so as not to obscure the present invention, such software components are omitted from the present discussion.

Still referring to FIG. 6, the software agents 665 collectively, among other things, schedule ahead one or more processing operations for each lot 645 on a specific qualified fabrication tool 615, including transports and required services. This includes making optimizing decisions such as running an incomplete batch, as opposed to waiting for approaching lots 645, and scheduling opportunistic preventive maintenance (“PM”) periods or qualification tests (“Quals”) to meet specifications. The software agents 665 schedule activities; initiate execution of scheduled activities (such as lot transport and processing); monitor factory states, appointment states, and alarm states in the factory that are relevant to the scheduled activities; and react to state changes arising from scheduled activities or unscheduled activities. The software agents 665 are specialized by the kind of manufacturing domain entity (i.e., process tool, lot, resource, etc.) and the function they perform (i.e., schedule, process, etc.).

The functionality of the test wafer controller 125 in the process flow 100 of FIG. 1 is distributed across the software agents 665, the MES 637 and the AMHS 638 implement in the process flow 600. For example of the distributed functionality, the software agents 665 also handle the scheduling tasks. As discussed above, the test wafer controller 125 schedules (at 420, FIG. 4B) processing appointments (at 530, FIG. 4C) and material transports (at 533, FIG. 4C) for consumption of the test wafers 650, 652 and appointments for processing lots 645 of available wafers through wafer build route (at 529, FIG. 4B).

More particularly, two scheduling software agents 665 negotiate with each other on behalf of the lot 645 and the fabrication tool 615 for an appointment in which the fabrication tool 615 will process the lot 645, whether as a part of consuming test wafers or as fabricating test wafers. Many techniques for scheduling appointments are known to the art, and any such technique may be employed. In one particular embodiment, however, appointments are scheduled using a contract net negotiation protocol in a floating market model approach. In the floating market model of the contract net negotiation protocol, the scheduling of actions initiated by the software agents 665 revolve around budgets, costs, and ratios associated with the processing in a contract net negotiation protocol. To further the implementation of a contract net negotiation protocol for allocating resources, a combination of budgets, costs, and ratios are used to implement a floating market model approach.

The combination of budgets, costs, and ratios is structured to encourage “desirable” behavior, e.g., meeting due dates, effective utilization of machines, etc. More particularly, a “budget” is assigned to the lot 645 that a software agent 665 uses to procure the process services. Similarly, the fabrication tool 615, charges consumers for the processing services it represents, e.g., processing time. The amount of the budget the lot 645 is willing to pay depends on how badly it needs to stay on schedule and the amount charged by the fabrication tool 615 depends on how badly it needs to fill its schedule. The lot 645 acquires services more or less aggressively depending on selected factors, such as priority or lateness. Process tools 615 provide such services more or less aggressively depending on a number of factors, such as the level of congestion in their calendars. Working in concert, the software agents 665 for consumers and providers of process services cooperate to advance the lots 645 through the process flow 600 in a timely and efficient manner.

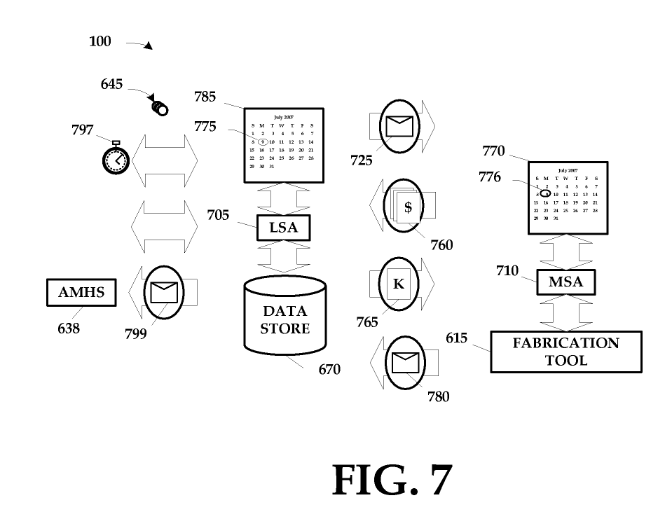

FIG. 7 illustrates the negotiation for and scheduling of processing appointments in the process flow 600. In the illustrated embodiment, the process flow 600 includes at least two types of software agent 665:
a lot scheduling agent (“LSA”) 705 representing the lot 645 for scheduling purposes; and
a machine scheduling agent (“MSA”) 710 representing the fabrication tool 615 for scheduling purposes.
   Although not shown, the illustrated embodiment also includes other types of agents. For instance, other types of manufacturing domain entities have respective scheduling agents. Some manufacturing domain entities also have corresponding “processing” agents, also not shown, to whom the scheduling agents pass control when it is time to initiate the execution of scheduled activities. These types of software agents 665 are instantiated for a lot 645 whenever it is created, or kitted, and are destroyed when the lot 645 is broken up, or de-kitted.

Each software agent 665 that schedules on behalf of some entity in the process flow 600 maintains a calendar of appointments in the illustrated embodiment. For instance, the LSA 705 keeps a calendar 785 and the MSA 710 keeps a calendar 770. The type of appointments scheduled on any given calendar will depend largely on the nature of the entity that the software agent 665 that is keeping the calendar represents. Thus, the LSA 705 will keep the calendar 785 and store therein not only processing appointments for its respective lot 645, but also move appointments the lost 645 needs to meet is processing appointments.

More particularly, the LSA 705 is responsible for scheduling current and future tasks on behalf of a specified lot 645 in the process flow 600. These tasks include manufacturing processing and material handling required to transform the lot 645 from raw silicon into a specified semiconductor product. A LSA 705 utilizes a calendar 785 to track scheduled tasks. The calendar 785 contains an ordered collection of appointments, e.g., the appointment 775, that represent active and future tasks scheduled by the LSA 705 that will provide the processing service required by the task. The types of appointments scheduled by the LSA 705 and a brief description thereof are summarized in Table 1. While these various appointment types contain different attributes, there are some attributes in common, including a scheduled start time, a scheduled end time, an estimated duration for how long the task will take and an appointment state.

TABLE 1
Appointments Booked by LSA

| Appt. Type | Appointment Description |
|---|---|
| Move | The lot is transported to a process tool. |
| Lot | The lot is processed on a process tool. |
| Carrier-in | The lot is loaded into a process tool. |
| Carrier-out | The lot is unloaded from a process tool. |
| Feeder | An appointment representing a scheduling |
| | constraint for operations between the current |
| | process operation and a process operation |
| | that has not yet been scheduled. |
| Maximum Move | An appointment that represents a scheduling |
| | constraint for moves of unknown duration between |
| | feeder and processing appointments where the |
| | tool to perform the processing operation represented by |
| | the feeder appointment is unknown. |

The MSA 710 also keeps a calendar 770 of appointments, e.g., the appointment 776, representing commitments of the fabrication tool 615 to provide process services-namely, processing time. The types of appointments scheduled by the MSA 710 on the calendar 770 are set forth in Table 2. Note that the lot processing appointment 776 scheduled by the MSA 710 on the calendar 770 corresponds to the processing appointment 775 scheduled by the LSA 705 on the calendar 785.

TABLE 2
Appointments Booked by MSA

| Appt. Type | Appointment Description |
|---|---|
| Lot Processing | A lot is processed on the process tools. |
| Setup | Process tool is prepared, or “setup,” for a different |
| | type of processing than it is currently processing. |
| PM | PM is performed on the process tool. |
| Qual | Stand-alone Qual is performed on the respective process |
| | tool. |
| Machine Batch | Multiple lots are assembled into a batch and |
| | processed simultaneously. |
| Unscheduled | Period in which machine is unexpectedly down, |
| Downtime | and set for anticipated duration. |

In the illustrated embodiment, the LSA 705 begins negotiating in a general scheduling session by publishing a bid request 725 to the MSA 710. The MSA 710 for each qualified fabrication tool 615 submits one or more bids 760 to the LSA 705 to process the lot 645. The LSA 705 accepts one of the bids 760. The LSA 705 then confirms the selected bid 760 with a message 765 to the MSA 710. The MSA 710 validates the selected bid 760 with its calendar 770, i.e., ensures that the selected bid 760 can still be implemented. The MSA 710 sees that the slot for the selected bid 760 is still clear, schedules the appointment 775, and sends a bid confirmed message 780 to the LSA 705. The LSA 705 then schedules the appointment 775 on its own calendar 785. When the start time for the scheduled processing appointment arrives, the scheduling agents 705, 710 pass control to respective processing agents (not shown). When one appointment completes, the LSA 705 and MSA 710 start their next appointment if it is time to do so. If it is not time, the LSA 705, MSA 710 set an alarm 797 and wait for the alarm 797 to fire, thereby indicating time to start the next appointment.

Thus, processing appointments, e.g., the processing appointments 775, 776 are booked on calendars, e.g., the calendars 785, 770, maintained by each scheduling agent, e.g., the scheduling agents 705, 710. Whenever the processing appointment 775 is booked, the LSA 705 schedules move appointments for moving the lots 645 to the location of the fabrication tool 615 associated with the newly booked processing appointment 775. As will be appreciated by those skilled in the art having the benefit of this disclosure, the process flow 600 will include a number of handling components, none of which are shown, such as stockers, wafer sorters, under-track storage, and work in progress (“WIP”) racks. The LSA 705 calls a “helper class object” called a move appointment scheduler (“MAS”, not shown) to schedule move appointments. The MAS determines the appropriate material transports required in order for the lot 645 to meet a confirmed processing appointment 775, including the utilization of handling components. Note that the handling components may have their own scheduling agents for this purpose.

The scheduling techniques illustrated in FIG. 7 and discussed immediately above can be implemented anytime scheduling is needed for the processing of wafers 645 on process tools 615. Thus, it can be used to schedules (at 420, FIG. 4B) processing appointments (at 530, FIG. 4C) and material transports (at 533, FIG. 4C) for consumption of the test wafers 650, 652. It can also be used to schedule appointments for processing lots 645 of available wafers through wafer build route (at 529, FIG. 4B). The difference lies in whether the LSA 705 and MSA 710 are scheduling for consumption and test wafer building, but this difference is transparent to the scheduling agents. The difference is similarly transparent for the processing agents. The difference is instead apparent to the TWSA 665a, which initiates the two different activities.

The information management inherent in the functionality of the test wafer controller 125 is also distributed in the process flow 600 of FIG. 6. As mentioned above, the process flow 600 includes one or more data stores 670. In the illustrated embodiment, a data store 670a stores data defining the state of the of the factory, including the process flow 600. The data store 670b stores data regarding selected metrics of the process flow 600. The data store 670c includes recipes, build routes, scripts, etc. employed in the actual processing performed on the process tool 615, meteorology tool 615′. These data stores 670 are updated and maintained through the operation of the AMHS 642, the notifiers 681, and the listeners 682, where applicable. The distributed information management supports the distributed functionality of the test wafer controller 125 in this particular embodiment.

For example, the management of the test wafer inventory 651 (at 310, FIG. 3) is performed by the test wafer start agent (“TWSA”) 665a. On initialization, the process flow 600 assesses its current state, which is then stored in a data store 670a. The assessment includes a tally of the various test wafers 650, 652 in the process flow 600 and their location. As the dormant wafers 652 leave the repository 651, the stored state 670a is updated through the network or notifiers and listeners 681, 682. Similarly, as the dormant wafers 652 are kitted into lots 645 and become active test wafers 650, are processed through the process flow 600 (whether for a test wafer build or for a qual), and then de-kitted and distributed, the stored state 670a is updated.

Thus, as is more generally illustrated in FIG. 5A, the TWSA 665a can monitor (at 410, FIG. 4A) the levels of test wafers 650, 652 by monitoring the fluctuations in the stored state 670a. The stored states 670a contains an inventory of the dormant test wafers 652 residing in a repository 653 by type both upon initializations and as the test wafers 652 are deposited in and withdrawn from the repository 653. As the stored state 670a is updated during the operation of the process flow 600, the test wafer usage is tracked and, since the type of the test wafer 650, 652 is an attribute thereof, or information in the metrics store 670b, the usage is tracked by type.

The number of uses for a given test wafer 650, 652 is also maintained as an attribute of the test wafer 650, 652 or in the metrics store 670b. Through the store 670a, the TWSA 665a knows or can ascertain which test wafers are in the process flow 600 (as opposed to the repository 653). Since, in this particular embodiment, the distribution will be a function of the number of as described above, the TWSA 665a can therefore predict the distribution of the consumed test wafers 652 by type.

The TWSA 665a therefore monitors (at 410, FIG. 4A) the levels of test wafers 650, 652 in the inventory 651 by type by: inventorying (at 510, FIG. 5A) the test wafers 652 residing in the repository 653 by type; tracking (at 513, FIG. 5A) test wafer usage in the automated process flow 600 by type; and predicting (at 516, FIG. 5A) the distribution of the consumed test wafers 650 by type. Thus, TWSA 665a knows just how many test wafers 652 are available by type and how many will eventually be available by type. In this particular embodiment, because of the granularity of the scheduling technique employed (discussed more fully below), the TWSA 700 can even project a reasonably certain time at which active test wafers 650 will actually be available.

Test wafer inventory management (at 310, FIG. 3) also includes building (at 413, FIG. 4A) new test wafers 650, 652, as described more generally in FIG. 4B, when desired, which is a function of the inventory levels and the “predetermined threshold”. Inventory levels are known through the monitoring process described above. The predetermined threshold is stored in a metrics store 670b, and the TWSA 665a can ascertain what that threshold is for each type by consulting the metrics store 670b. Note that this implies that the predetermined threshold varies as a function of the type of the test wafer 650, 652. However, this is not necessary to the practice of the invention, and a single predetermined threshold may be used for all types in alternative embodiments. As discussed above, when the stock of a given type of test wafers 650, 652, falls below the predetermined threshold, the TWSA 665a initiates the build of additional test wafers 650, 652 of that type.

The TWSA 665a can identify the test wafer type whose level has dropped below the predetermined threshold by periodically checking inventory levels against the predetermined threshold. Both of these values may be, for instance, kept in and retrieved from the metrics store 670b. As those in the art having the benefit of this disclosure will appreciate, each type of test wafer 650, 652 may be built uniquely relative to the other types. Thus, the build route, or series of operations, for that particular type is retrieved from, for instance a data store 670c containing such information regarding the infrastructure and operation of the system. The TWSA 665a then establishes a lot 645 of wafers 650 (only one indicated), typically dormant wafers 652 or blanks 654 (only one indicated). The wafers 650 will typically be of another type that have been designated for this purpose as was described above. This information may also be stored in, for example, the store 670c.

As a further example, the functionality of the test wafer controller 125, shown in FIG. 1, is also distributed across the process flow 600 of FIG. 6. The scheduling scenario described above can be adapted in some embodiments to schedule on behalf of the test wafers 650, 652. Manufacturing domain entities function as either consumers or providers of processing resources within the process flow 600 as was discussed above. In the example of FIG. 7, the lot 645 is a consumer and the fabrication tool 615 in the sense that the lot 645 “consumes” the process time “provided” by the fabrication tool 615.

However, the test wafers 650, 652—and the lots 645 they comprise—are fundamentally different in that they can behave as both consumers and providers in the process flow 600 depending on their state. Test wafers 650, 652 behave as consumers in the phase of their existence in which they are being built because they are consuming the processing time of fabrication tools 615. Test wafers 650, 652 also behave as providers when they are being used to qualify fabrication tools 615. Conventional scheduling agents that act only in a “provider” or “consumer” mode therefore are not suitable for scheduling lots 645 of test wafers 650, 652.

The present invention therefore, in some embodiments, distributes the scheduling functionality of the test wafer controller 125 for test wafers 650, 652 over a plurality of test lot scheduling agents (“TLSA”) 686. Each time a lot 645 of test wafers 650, 652 is kitted as described above, a TLSA 686 is instantiated in the same manner as other software implemented agents. The state and goal of the kitted lot 645 can be ascertained by the instantiated TLSA 686 from the data stores 670.

If the lot 645 is being kitted for the build of additional test wafers, the TLSA 686 can ascertain this from the data stores 670 and begin scheduling processing activities with fabrication tools 615 from a consumer's perspective. Once the test wafers 650, 652 are built, they are either returned to the inventory 651 or placed into the process flow 600 for utilization as a resource. If they are returned to inventory, the TLSA 868 is destroyed when the lot 645 is de-kitted.

When a lot 645 of test wafers 650, 652 goes into the process flow 600 as a resource for testing fabrication tools 615, the TLSA 686 begins scheduling from a provider's perspective. The lot 645 may have entered the process flow directly from the build process as alluded to above, in which case the TLSA 686 has already been instantiated. When the roll of the lot 645 changes from consumer to provider, so to do the scheduling activities performed by the TLSA 686. That is, the TLSA 686 shifts roles from consumer scheduling to provider scheduling. If the lot 645 is kitted from the inventory 651 for this purpose, a new TLSA 686 is instantiated to represent it. In either scenario, the TLSA 686 is destroyed whenever the lot 645 is de-kitted.

Note that, in some embodiments, the dual functionality of the TLSA 686 in terms of representing both a consumer and a provider may be broken down into two separate scheduling agents. Thus, a test lot 645 may have one type of TLSA when slated for a build and a second type of TLSA when slated for use in a qual or a PM. Still further specialization may be used as well. For example, a test lot slated for a build might be assigned a scheduling agent whose nature will depend on whether it is slated for a Type I build, a Type II build, etc. Still further, a test lot slated for consumption in a qual might be assigned a scheduling agent different from the scheduling agent it might be assigned for consumption in a PM. Other kinds of specialization may become apparent to those skilled in the art having the benefit of this disclosure.

The TLSA 686 in the illustrated embodiment also executes other functionalities of the test wafer controller 125, shown in FIG. 1, in addition to scheduling. The TLSA 686 can, for instance, assign a priority to its respective lot 645 based on inventory needs. The TLSA 686 can then also schedule activities responsive to that priority.

An additional functionality inheres from the operation of the TLSAs 686 and the test wafer controller 125 in that the scheduling of PM and qual activities will comprehend wafer resource availability. If there is a shortage of the appropriate type of test wafers 650, 652 for a given PM or qual, then the costs for scheduling this activity will rise accordingly. PM and Qual activities will therefore self-order in terms of which are more immediately needed on the basis of willingness to pay higher costs. Conversely, if there is a glut of test wafers 650, 652, then the costs for PM and Qual activities will decrease and these activities will be conducted more readily.

Thus, the present invention can be extrapolated across an entire fabrication facility. The extrapolation of the invention across the process flow 600 in FIG. 6 is distributes much of the functionality and structure. Furthermore, the technique is highly scalable. These features will facilitate extrapolation across even larger process flows to entire facilities more readily than some other approaches. However, other embodiments may employ other techniques to perform such an extrapolation.

As mentioned above, in the illustrated embodiment, the invention is implemented using object oriented programming (“OOP”) techniques, although the invention may be implemented using techniques that are not object oriented. The software agents 665 are implemented as objects and are intelligent, state aware, and are imbued with specific goals for which they autonomously initiate behaviors to achieve. Their behavior is relatively simple and is partially configurable through scripts and properties. The behavior is designed to achieve selected goals such as achieving an assigned lot due date, achieving a predefined level of quality, maximizing machine utilization, and scheduling opportunistic preventive maintenance. The helper class is a class of objects to which various objects that are software agents 665 delegate various responsibilities or that provide some useful service in the process flow 600.

Some portions of the detailed descriptions herein are consequently presented in terms of a software implemented process involving symbolic representations of operations on data bits within a memory in a computing system or a computing device. These descriptions and representations are the means used by those in the art to most effectively convey the substance of their work to others skilled in the art. The process and operation require physical manipulations of physical quantities. Usually, though not necessarily, these quantities take the form of electrical, magnetic, or optical signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated or otherwise as may be apparent, throughout the present disclosure, these descriptions refer to the action and processes of an electronic device, that manipulates and transforms data represented as physical (electronic, magnetic, or optical) quantities within some electronic device's storage into other data similarly represented as physical quantities within the storage, or in transmission or display devices. Exemplary of the terms denoting such a description are, without limitation, the terms “processing,” “computing,” “calculating,” “determining,” “displaying,” and the like.

Note also that the software implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

This concludes the detailed description. The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. An automated, computer-implemented method for managing test wafers in an integrated, automated semiconductor manufacturing environment, the method comprising:
managing a test wafer inventory;
consuming inventoried test wafers in the automated process flow; and
distributing the consumed test wafers according to their level of usage after an evaluation thereof.

2. The automated, computer-implemented method of claim 1, wherein managing the test wafer inventory includes:
monitoring the levels of a plurality of types of test wafers in inventory; and
building test wafers of a given type should the level of the given type fall below a predetermined threshold

3. The automated, computer-implemented method of claim 2, wherein monitoring the levels includes:
inventorying the test wafers residing in a repository by type;
tracking test wafer usage in the automated process flow by type; and
predicting the distribution of the consumed test wafers by type.

4. The automated, computer-implemented method of claim 2, wherein building test wafers includes:
identifying the test wafer type whose level has dropped below the threshold;
determining a test wafer build route for the identified test wafer type;
establishing a lot of available wafers; and
processing the lot through the test wafer build route.

5. The automated, computer-implemented method of claim 2, wherein managing the test wafer inventory further includes depositing the built test wafers in a repository.

6. The automated, computer-implemented method of claim 1, wherein consuming the test wafers includes:
scheduling the consumption;
kitting a lot of the test wafers;
processing the kitted lot according to a process route;
evaluating the wafers of the kitted lot after the processing; and
de-kitting the lot after the evaluation.

7. The automated, computer-implemented method of claim 6, wherein scheduling the consumption includes:
scheduling an appointment on a process tool for processing kitted lot; and
scheduling material transports for the kitted lot to arrive at the process tool for the scheduled process appointment.

8. The automated, computer-implemented method of claim 6, wherein kitting the lot includes:
ascertaining the composition of the lot by number and type of test wafer;
identifying particular test wafers by type to meet the composition of the lot; and
assembling the identified test wafers into the lot.

9. The automated, computer-implemented method of claim 6, wherein de-kitting the lot includes disassembling the kitted test wafer from the lot for automatic distribution according to their usage.

10. The automated, computer-implemented method of claim 1, wherein evaluation the wafers includes ascertaining the level of usage for a given consumed test wafer.

11. The automated, computer-implemented method of claim 10, wherein distributing the consumed wafers includes disposing of the given consumed test wafer based upon the ascertained level of usage.

12. The automated, computer-implemented method of claim 1, wherein distributing the consumed wafers includes disposing of the given consumed test wafer based upon the ascertained level of usage.

13. The automated, computer-implemented method of claim 12, wherein disposing of the given consumed test wafer includes one of:
returning the given test wafer for further consumption at the same type;
downgrading the given test wafer to a second type; and
consigning the given test wafer to a waste bin.

14. An integrated, automated semiconductor manufacturing environment, comprising:
a process flow;
an inventory of test wafers; and
a programmed computing system capable of:
managing the test wafer inventory;
consuming test wafers from the inventory by an automate process flow; and
distributing the consumed test wafers according to their level of usage after an evaluation thereof.

15. The integrated, automated semiconductor manufacturing environment of claim 14, wherein managing the test wafer inventory includes:
monitoring the levels of a plurality of types of test wafers in inventory; and
building test wafers of a given type should the level of the given type fall below a predetermined threshold

16. The integrated, automated semiconductor manufacturing environment of claim 14, wherein consuming the test wafers includes:
scheduling the consumption;
kitting a lot of the test wafers;
processing the kitted lot according to a process route;
evaluating the wafers of the kitted lot after the processing; and
de-kitting the lot after the evaluation.

17. The integrated, automated semiconductor manufacturing environment of claim 14, wherein evaluation the wafers includes ascertaining the level of usage for a given consumed test wafer.

18. The integrated, automated semiconductor manufacturing environment of claim 14, wherein distributing the consumed wafers includes disposing of the given consumed test wafer based upon the ascertained level of usage.

19. A program storage medium encoded with instructions that, when executed by a computing device, perform a method comprising:
managing a test wafer inventory;
consuming test wafers from the inventory by an automated process flow; and
distributing the consumed test wafers according to their level of usage after an evaluation thereof.

20. The program storage medium of claim 19, wherein managing the test wafer inventory in the method includes:
monitoring the levels of a plurality of types of test wafers in inventory; and
building test wafers of a given type should the level of the given type fall below a predetermined threshold

21. The program storage medium of claim 19, wherein consuming the test wafers in the method includes:
scheduling the consumption;
kitting a lot of the test wafers;
processing the kitted lot according to a process route;
evaluating the wafers of the kitted lot after the processing; and
de-kitting the lot after the evaluation.

22. The program storage medium of claim 19, wherein evaluation the wafers in the method includes ascertaining the level of usage for a given consumed test wafer.

23. The program storage medium of claim 19, wherein distributing the consumed wafers in the method includes disposing of the given consumed test wafer based upon the ascertained level of usage.

24. An automated, computer-implemented method for use in semiconductor manufacturing, comprising:
monitoring test wafer utilization in an automated process flow;
maintaining an inventory of test wafers of a plurality of different types responsive to the monitored utilization; and
managing the test wafer utilization of the test wafer inventory.

25. The automated, computer-implemented method of claim 24, wherein maintaining the inventory includes:
monitoring the levels of a plurality of types of test wafers in the inventory; and
building test wafers of a given type should the level of the given type fall below a predetermined threshold.

26. The automated, computer-implemented method of claim 25, wherein monitoring the levels includes:
inventorying the test wafers residing in a repository by type;
tracking test wafer usage in the automated process flow by type; and
predicting the distribution of the consumed test wafers by type.

27. The automated, computer-implemented method of claim 25, wherein building test wafers includes:
identifying the test wafer type whose level has dropped below the threshold;
determining a test wafer build route for the identified test wafer type;
establishing a lot of available wafers;
processing the lot through the test wafer build route.

28. The automated, computer-implemented method of claim 25, wherein managing the test wafer inventory further includes depositing the built test wafers in a repository.

29. The automated, computer-implemented method of claim 24, wherein maintaining the inventory includes distributing consumed test wafers according to their level of usage after an evaluation thereof.

30. The automated, computer-implemented method of claim 29, wherein distributing the consumed wafers includes:
ascertaining the level of usage for a given consumed test wafer; and
disposing of the given consumed test wafer based upon the ascertained level of usage.

31. The automated, computer-implemented method of claim 30, wherein disposing of the given consume test wafer includes one of:
returning the given test wafer for further consumption at the same type;
downgrading the given test wafer to a second type; and
consigning the given test wafer to a waste bin.

32. The automated, computer implemented method of claim 24, wherein maintaining the inventory includes:
monitoring the levels of a plurality of types of test wafers in the inventory;
building test wafers of a given type should the level of the given type fall below a predetermined threshold; and
distributing consumed test wafers according to their level of usage after an evaluation thereof.

33. The automated, computer implemented method of claim 32, wherein building test wafers includes:
determining that the level of the given type of test wafer has fallen below a predetermined threshold;
scheduling a test wafer build in the processing flow; and
executing the scheduled test wafer build.

34. The automated, computer-implemented method of claim 24, wherein managing the test wafer utilization of the test wafer inventory includes:
scheduling a consumption of a lot of test wafers;
kitting the lot;
processing the kitted lot according to a process route; and
de-kitting the lot after an evaluation.

35. The automated, computer-implemented method of claim 34, wherein scheduling the consumption includes:
scheduling an appointment on a process tool for processing kitted lot; and
scheduling material transports for the kitted lot to arrive at the process tool for the scheduled process appointment.

36. The automated, computer-implemented method of claim 34, wherein kitting the lot includes:
ascertaining the composition of the lot by number and type of test wafer;
identifying particular test wafers by type to meet the composition of the lot; and
assembling the identified test wafers into the lot.

37. The automated, computer-implemented method of claim 34, wherein de-kitting the lot includes disassembling the kitted test wafer from the lot for automatic distribution according to their usage.

38. The automated, computer-implemented method of claim 24, further comprising evaluating the test wafers consumed by the automated process flow.

39. An apparatus, comprising:
an automated process flow;
a lot including at least one test wafer;
a test wafer controller capable of:
monitoring test wafer utilization in the automated process flow;
maintaining an inventory of test wafers of a plurality of different types responsive to the monitored utilization; and
managing the test wafer utilization of the test wafer inventory.

40. The apparatus of claim 39, wherein the lot further includes a second test wafer.

41. The apparatus of claim 39, further comprising:
a first scheduling agent representing the lot;
a second scheduling agent representing a fabrication tool and cooperatively scheduling with the first scheduling agent a process operation in a test build on the fabrication tool.

42. The apparatus of claim 41, wherein the first and second scheduling agents cooperatively schedule using a contract net negotiation protocol.

43. The apparatus of claim 39, further comprising a meteorology tool on which the scheduler is capable of scheduling the processed test wafer for evaluation.

44. The apparatus of claim 43, further comprising:
a first scheduling agent representing the lot; and
a second scheduling agent representing the meteorology tool cooperatively scheduling with the first scheduling agent an evaluation of the lot on the meteorology tool.

45. An automated, computer-implemented method for use in semiconductor manufacturing, comprising:
kitting a lot of test wafers;
instantiating a software-implemented test lot scheduling agent for the kitted lot, the agent being capable of:
scheduling a build for the kitted lot; or
scheduling the kitted lot as a resource for consumption in an automated process flow.

46. The automated, computer-implemented method of claim 45, wherein scheduling a build includes:
identifying the test wafer type whose level has dropped below the threshold; and
determining a test wafer build route for the identified test wafer type.

47. The automated, computer-implemented method of claim 45, wherein scheduling the consumption includes:
scheduling an appointment on a process tool for processing kitted lot; and
scheduling material transports for the kitted lot to arrive at the process tool for the scheduled process appointment.

48. The automated, computer-implemented method of claim 45, wherein scheduling the consumption includes scheduling for consumption in a preventive maintenance period or a qualification run.

49. The automated, computer-implemented method of claim 45, wherein the software-implemented test lot scheduling agent is capable of both:
scheduling a build for the kitted lot; and
scheduling the kitted lot as a resource for consumption in an automated process flow.

50. The automated, computer-implemented method of claim 45, wherein the software-implemented test lot scheduling agent is capable of only one of:
scheduling a build for the kitted lot; and
scheduling the kitted lot as a resource for consumption in an automated process flow.

51. An apparatus, comprising:
an automated process flow, including:
a plurality of process tools; and
a lot including at least one test wafer; and
a computing system controlling the automated process flow, including:
a software-implemented test lot scheduling agent capable of:
scheduling a build for the lot on the process tools; and
scheduling the lot as a resource for consumption by the process tools.

52. The apparatus of claim 51, wherein scheduling a build includes:
identifying the test wafer type whose level has dropped below the threshold; and
determining a test wafer build route for the identified test wafer type.

53. The apparatus of claim 51, wherein scheduling the consumption includes:
scheduling an appointment on a process tool for processing kitted lot; and
scheduling material transports for the kitted lot to arrive at the process tool for the scheduled process appointment.

54. The apparatus of claim 51, wherein scheduling the consumption includes scheduling for consumption in a preventive maintenance period or a qualification run.

55. The apparatus of claim 51, wherein the software-implemented test lot scheduling agent is capable of both:
scheduling a build for the kitted lot; and
scheduling the kitted lot as a resource for consumption in an automated process flow.

56. The apparatus of claim 51, wherein the software-implemented test lot scheduling agent is capable of only one of:
scheduling a build for the kitted lot; and
scheduling the kitted lot as a resource for consumption in an automated process flow.

57. A program storage medium encoded with instructions that, when executed by a computing device, perform a method for use in semiconductor manufacturing, comprising:
kitting a lot of test wafers;
instantiating a software-implemented test lot scheduling agent for the kitted lot, the agent being capable of:
scheduling a build for the kitted lot; or
scheduling the kitted lot as a resource for consumption in an automated process flow.

58. The program storage medium of claim 57, wherein scheduling a build includes:
identifying the test wafer type whose level has dropped below the threshold; and
determining a test wafer build route for the identified test wafer type.

59. The program storage medium of claim 57, wherein scheduling the consumption includes:
scheduling an appointment on a process tool for processing kitted lot; and
scheduling material transports for the kitted lot to arrive at the process tool for the scheduled process appointment.

60. The program storage medium of claim 57, wherein scheduling the consumption includes scheduling for consumption in a preventive maintenance period or a qualification run.

61. The program storage medium of claim 57, wherein the software-implemented test lot scheduling agent is capable of both:
scheduling a build for the kitted lot; and
scheduling the kitted lot as a resource for consumption in an automated process flow.

62. The program storage medium of claim 57, wherein the software-implemented test lot scheduling agent is capable of only one of:
scheduling a build for the kitted lot; and
scheduling the kitted lot as a resource for consumption in an automated process flow.
